(19) United States
(12) Patent Application Publication
(10) Pub. No.: US 2021/0224046 A1
(43) Pub. Date: Jul. 22, 2021

(54) Workflow engine for generating code based on visualizations

(71) Applicant: Ontology-Partners Ltd, London (GB)

(72) Inventor: Daniel Burrell, London (GB)

(21) Appl. No.: 17/151,361

(22) Filed: Jan. 18, 2021

Related U.S. Application Data
(60) Provisional application No. 62/963,750, filed on Jan. 21, 2020.
(60) Provisional application No. 63/047,967, filed on Jul. 3, 2020.

(51) Int. Cl. G06F 8/34

(52) U.S. Cl. CPC G06F 8/34

(57) ABSTRACT

Systems and methods include presenting a user interface to a user for generating a workflow; obtaining a visualization of the workflow via the user interface, wherein the visualization is a directed graph with vertices including actions, scenarios for the actions, outputs, and inputs, and with directed edges between the vertices; and processing the visualization graph to generate code based thereon. The code can be YAML Ain't Markup Language (YAML), Extensible Markup Language (XML), and JavaScript Object Notation (JSON).

### CROSS-REFERENCE TO RELATED APPLICATION(S)

The present disclosure relates to U.S. Provisional Patent Application No. 62/963,750, filed Jan. 21, 2020, and U.S. Provisional Patent Application No. 63/047,967, filed Jul. 3, 2020, the contents of which are incorporated by reference in their entirety.

### FIELD OF THE DISCLOSURE

The present disclosure generally relates to computing. More particularly, the present disclosure relates to systems and methods for a workflow engine for generating code based on visualizations.

### BACKGROUND OF THE DISCLOSURE

There are various software products, modules, applications, services, and/or devices available, each having inputs and providing outputs to perform some functionality. For illustration purposes, these are collectively referred to herein as applications or services, and it is noted these applications or services operate independently from one another. For example, the applications can be from different companies, can be developed by different teams in the same company, can be purchased, etc. It is often desirable to have independent modules operate together. Thus, there is a need to integrate these applications, such as via Application Programming Interfaces (APIs). That is, a way to use inputs/outputs between the different modules for performing their associated operation together. In a non-limiting example, in a networking scenario, the different applications can include an alarm application, a Key Performance Indicator (KPI) application, a trouble ticket application, a network topology application, a testing application, a network management application, etc. A simple integration example may include having outputs of the alarm application connect as inputs to the trouble ticket application, i.e., have certain outputs of the alarm application be inputs to the trouble ticket application for creating open tickets based on alarms. Of course, those skilled in the art will recognize various other examples are possible, including ones outside of networking. One approach for application integration can be a professional services team that writes software code for each integration. The disadvantage here is the need for code generating expertise and the speed, i.e., it takes significant time to generate code. Further, as expected, there can be a lot of required integration of various applications, and speed and efficiency are critical.

To counter the inefficiency of code generation, workflow automation tools (“design tools”) have been developed to allow a user to visually define the integration, such as via a directed graph. As known in the art, a directed graph is one having vertices with directed edges connecting the vertices and with the edges having a direction associated with it. Here, the vertices can be the applications, and the vertices can be the flow of inputs and outputs. An example design tool includes Orquesta, which is a graph-based workflow engine for StackStorm. Generally, the design tools allow for a user to design the integration between modules visually, without resorting to generating code. An output of the visual design graph can be used to generate code, such as YAML, XML, etc. code. This approach introduces efficiency, speed, and does not require the same level of expertise for the use, i.e., code generation knowledge.

A workflow is an ordered tree of programmable and configurable actions, which are described in sequence. The workflow may branch and merge. This workflow can be executed by a workflow engine provided it is correctly described in valid YAML code (or another type of code). YAML (YAML Ain't Markup Language) is a human-readable data serialization language that is used for configuration files and for applications where data is being stored or transmitted (i.e., the inputs and the outputs). YAML is similar to Extensible Markup Language (XML), which can also be used as well as other types of code. The goal with a design tool is to allow the user to draw the workflow and have the design tool automatically generate the valid YAML code. Many existing design tools allow a user to define the relationships between the actions in a sequence or branching model, however when it comes to data binding, only some tools allow the user to define the relationships visually, and these typically take on a 1:1 mapping of inputs to outputs. When it comes to defining loops, the user is often expected to leave the comfort of the design tool and write code to express the loop, defeating the purpose of the visual design tool. In some cases where the user does not leave the design tool, the loops are trivial, and the expressiveness or ability to combine loops or decouple the consumption of the data is lost.

That is, existing design tools can perform linear tasks well, and generate the associated code. However, the existing design tools do not support loops and generating code based thereon.

### BRIEF SUMMARY OF THE DISCLOSURE

The present disclosure relates to systems and methods for a workflow engine for generating code based on visualizations. Specifically, the present disclosure includes a computer-implemented method for a design tool, a processing device configured to implement the design tool, and a non-transitory computer-readable medium having instructions stored thereon for programming the processing device to implement the design tool. The design tool is for users to visually implement workflows where each action has inputs and scenarios, and where each scenario has outputs. Again, a workflow is an ordered tree of programmable and configurable actions, which are described in sequence. The workflow may branch and merge. This workflow can be executed by a workflow engine provided it is correctly described in valid YAML code. The objective with the design tool is to allow a user to draw the workflow, and have the design tool automatically generate the valid YAML code. Existing workflow tools allow a user to define the relationships between the actions in a sequence or branching model, however when it comes to data binding, only some tools allow you to define the relationships visually, and these typically take on a 1:1 mapping of inputs to outputs. When it comes to defining loops, the user is often expected to leave the design tool and write code to express the loop. In some cases where the user does not leave the UI, the loops are trivial, and the expressiveness or ability to combine loops or decouple the consumption of the data is lost.

The present disclosure focuses on this ability to express variations of the while loop visually to translate into code. In an example embodiment, the target language can be Orquesta for StackStorm—an Open Source Workflow Engine. That is, the workflow engine can be a StackStorm workflow engine. The present disclosure was borne out of necessity as the existing tooling required the user to write Jinja expressions and understand the StackStorm Orquestra format of YAML. Note, YAML is an example output, and the present disclosure contemplates other types of code such as XML, JavaScript Object Notation (JSON), etc.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a diagram of an example workflow;

FIG. 2 is a diagram of an example workflow where an input list is consumed without iteration;

FIG. 3 is an example of code automatically generated based on the workflow of FIG. 2;

FIG. 4 is a diagram of an example workflow where an input list is consumed for each item;

FIG. 5 is an example of code automatically generated based on the workflow of FIG. 4;

FIG. 6 is a diagram of an example workflow where a separate execution of an action is performed for each element in a list;

FIG. 7 is an example of code automatically generated based on the workflow of FIG. 6;

FIG. 8 is a diagram of an example workflow which is a combination of the workflows of FIGS. 2 and 4;

FIG. 9 is an example of code automatically generated based on the workflow of FIG. 8;

FIG. 10 is a diagram of an example workflow to express zipped lists diagrammatically where given lists of equal size are iterated over the elements as named pairs;

FIG. 11 is an example of code automatically generated based on the workflow of FIG. 10;

FIG. 12 is a diagram of an example workflow to expand the workflow to provide context;

FIG. 13 is an example of code automatically generated based on the workflow of FIG. 12;

FIGS. 14-21 are diagrams of workflows illustrating a set of concepts and relations that are modeled in the abstract; and

FIG. 22 is a block diagram of a processing device for implementing the design tool.

### DETAILED DESCRIPTION OF THE DISCLOSURE

Again, the present disclosure relates to systems and methods for a workflow engine for generating code based on visualizations. Specifically, the present disclosure includes a computer-implemented method for a design tool, a processing device configured to implement the design tool, and a non-transitory computer-readable medium having instructions stored thereon for programming the processing device to implement the design tool. The design tool is for users to visually implement workflows where each action has inputs and scenarios, and where each scenario has outputs. Again, a workflow is an ordered tree of programmable and configurable actions, which are described in sequence. The workflow may branch and merge. This workflow can be executed by a workflow engine provided it is correctly described in valid YAML code. The objective with the design tool is to allow a user to draw the workflow, and have the design tool automatically generate the valid YAML code. Existing workflow tools allow a user to define the relationships between the actions in a sequence or branching model, however when it comes to data binding, only some tools allow you to define the relationships visually, and these typically take on a 1:1 mapping of inputs to outputs. When it comes to defining loops, the user is often expected to leave the design tool and write code to express the loop. In some cases where the user does not leave the UI, the loops are trivial, and the expressiveness or ability to combine loops or decouple the consumption of the data is lost.

The present disclosure focuses on this ability to express variations of the while loop visually to translate into code. In an example embodiment, the target language can be Orquesta for StackStorm—an Open Source Workflow Engine. That is, the workflow engine can be a StackStorm workflow engine. The present disclosure was borne out of necessity as the existing tooling required the user to write Jinja expressions and understand the StackStorm Orquestra format of YAML. Note, YAML is an example output, and the present disclosure contemplates other types of code such as XML, JavaScript Object Notation (JSON), etc.

### Example Workflow

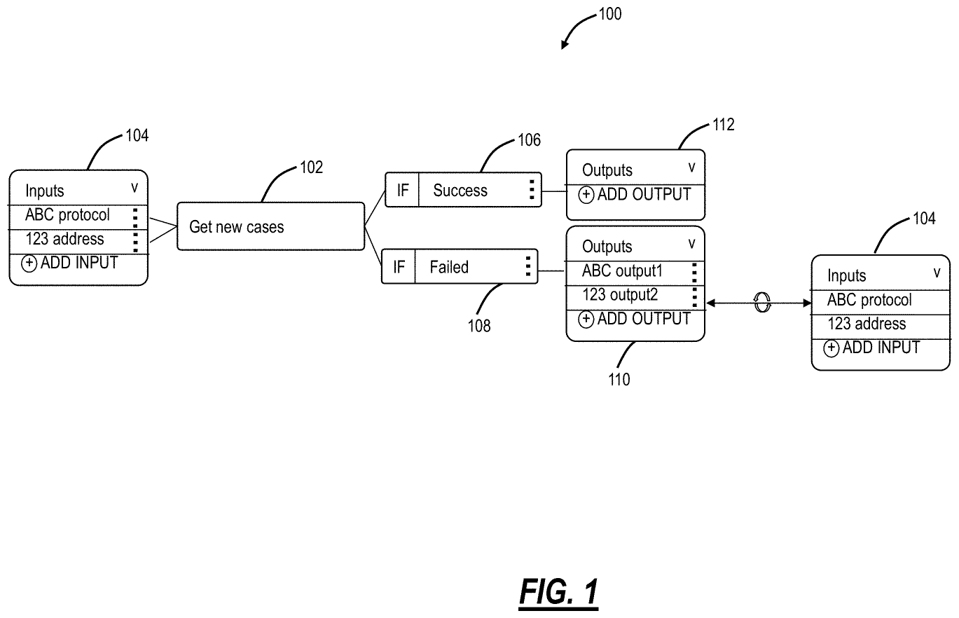

FIG. 1 is a diagram of an example workflow 100. The workflow 100 is via the design tool and is presented visually, such as in a Graphical User Interface (GUI). Those skilled in the art understand a user can interact with the GUI, such as via drag and drop, to create the workflow 100. The workflow 100 is made up of a set of action nodes 102. To function, these action nodes 102 define inputs 104. Also, the action node 102 is a visual representation of an action. The term action may be used herein interchangeably with the term action node 102. The outcome of an action of the action node 102 can vary, for example, an action may have a success scenario 106, or there may be an error scenario 108. Depending on the error code, the user may want to take different actions. The error code can be represented as an output 110 for the error scenario 108. And the result can be an output 112 for the success scenario 106. Error and success are concrete examples for this illustration, and there is no limit to the number of scenarios in practice. To this end, the action nodes 102 have inputs 104, and scenario outcomes, each scenario outcome has a number of outputs 110, 112 as necessary. Note, the action node 102 or action itself does not have outputs; outputs only exist through scenarios implemented by the action nodes 102.

In FIG. 1, there is an action node 102 called ‘Get new cases,’ which is designed to query a service for any newly created cases. It has two inputs 104, namely ‘protocol’ and ‘address.’ There are two scenarios, the success scenario 106 and the error scenario 108. The success scenario 106 could represent the situation where there are new cases. The error scenario 108 could represent where there are no new cases. The success scenario 106, in this case, has no outputs associated with it, though the user can add to this list by clicking the add output button and selecting an output from a well-defined list. The error scenario 108 has been developed more, in this example, as there are two outputs, output1 and output2, these could represent the error code and the stack trace, for example. These outputs can then be wired to the input of the next element in the sequence. In this case, the protocol input of the next action is bound to output2.

### Processing Lists

One of the elements (outputs) from a given scenario is a ‘list.’ A list is a collection of data elements. Presumably, some action would like to operate on this list. There are a number of different ways a list may be processed, as is described herein. The following describes each situation and illustrates where combinations may occur. Again, the design tool is configured to enable a user to describe list processing visually and to map the visual representation to a code representation.

Specifically, the design tool provides a mechanism by which the user can express all of the following loop processing methods without writing any code. Again, many workflow tools are existing, but few of them either mention looping or are as expressive with the data without resorting to code. Expressing loops without resorting to code is something that has evaded even the current tooling. Again, in an embodiment, the code is YAML, but other data formats apply equally, XML, JSON etc. The result is that the user does not have to be familiar with code, or painstakingly match names and labels; they can simply express the loop as a series of lines connecting joints. In particular, the design tool can decouple the list consumption from the list iteration. All this together lowers the bar of entry for the user and ensures they do not need to understand code to write workflows.

Input List Consumption without Iteration

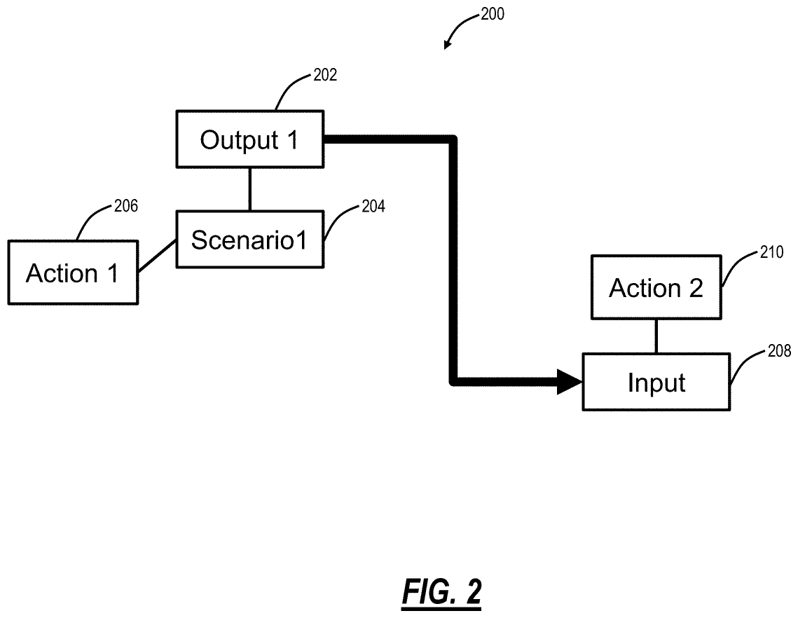

FIG. 2 is a diagram of an example workflow 200 where an input list is consumed without iteration. Here, a list from an output 202 of one scenario 204 associated with an action 206 is provided to be consumed as an input 208 to another action 210. Here, the output 202 is bound to the input 208 of the action 210. This is not a loop. Assume that the output 202 is a list, and the input 208 one takes that list as is and does not iterate over it. That is, the workflow 200 supplies a list from the output of one scenario to be consumed as the input of another action. The action may operate on the list internally if it wants to, but critically:

The action itself will only be invoked once;

The list will be passed as input;

Example “An action which derives a list of servers, passes the list to an action which persists the list to disk as a single operation.”

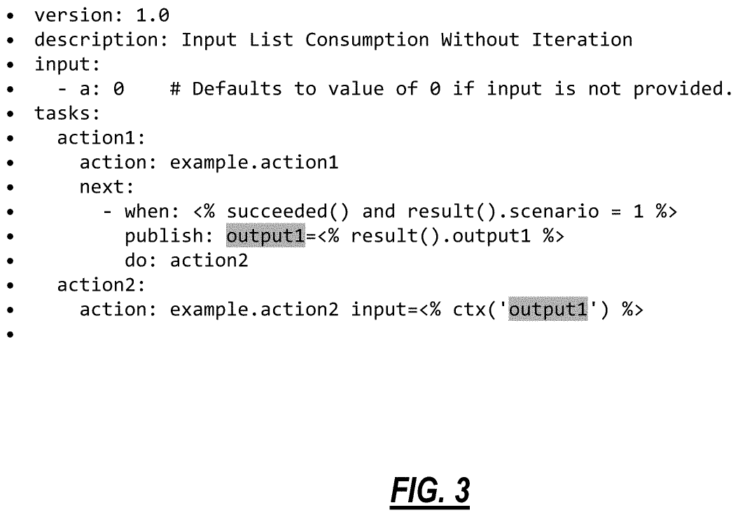

FIG. 3 is an example of code automatically generated based on the workflow 200.

### Input List Consumed for Each Item

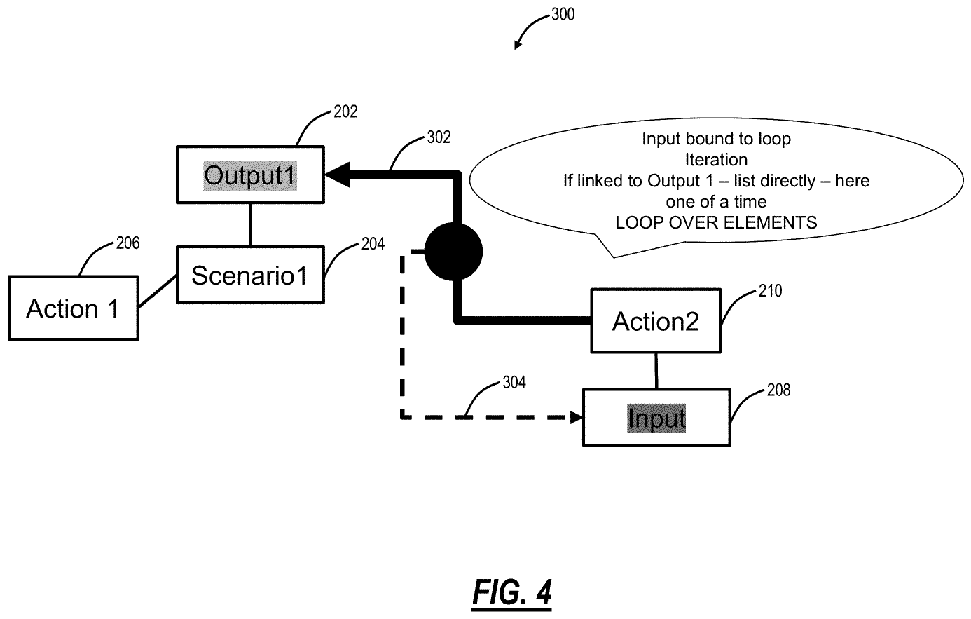

FIG. 4 is a diagram of an example workflow 300 where an input list is consumed for each item. In the workflow 300, there are two relationships, first, the action 210 should be executed for each element in the output 202, this is a line 302. And second that each element from that iteration should be consumed by the input 208. Note, that a dashed line 304 is not linked to the output 202 directly, it is linked to the iteration relationship. For completeness, IF it were linked to the output 202, that would mean it was consuming the list directly for every invocation of the action 210. This is described later and is a key aspect of the design tool. Existing design tools defer to the user at this point to write some code. But here, the present disclosure allows a user to loop over the elements, and later it is shown how detaching the inputs from the looping logic provides an ability to describe a variety of looping scenarios. In the workflow 300, for each item in the list, the action 210 should be executed. Crucially:

The action 210 is invoked once for each item in the list.

Each item in the list is passed to a separate invocation of the action 210.

The full context of the list is not made available (unless the user provides it as a separate input, as is shown later).

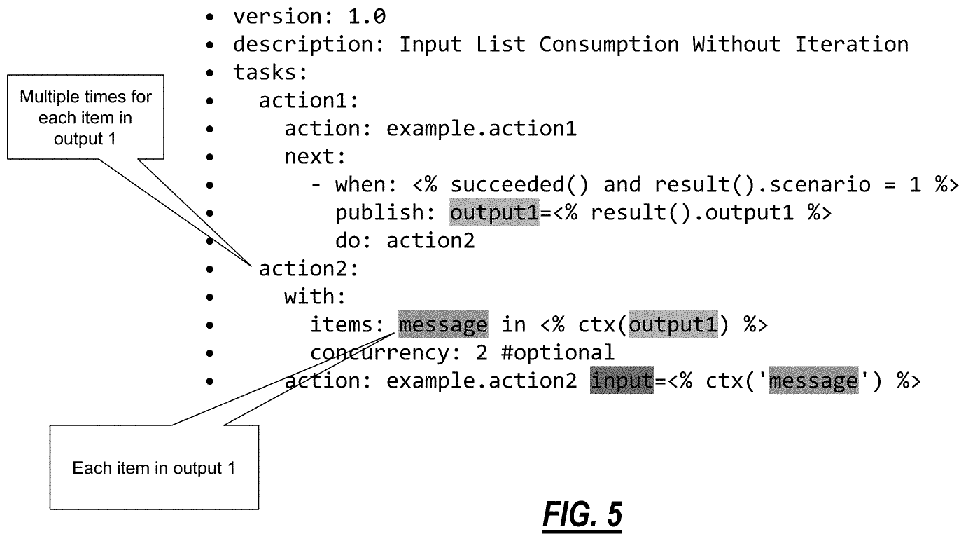

FIG. 5 is an example of code automatically generated based on the workflow 300. In practice, it is desirable to ensure that any bound variables are made unique, regardless of what is displayed to the user. But to keep things simple, FIGS. 3, 5, 7, etc. omit the unique Identity number and use highlighting to represent identically named variables.

For Each Item in the List without Consumption

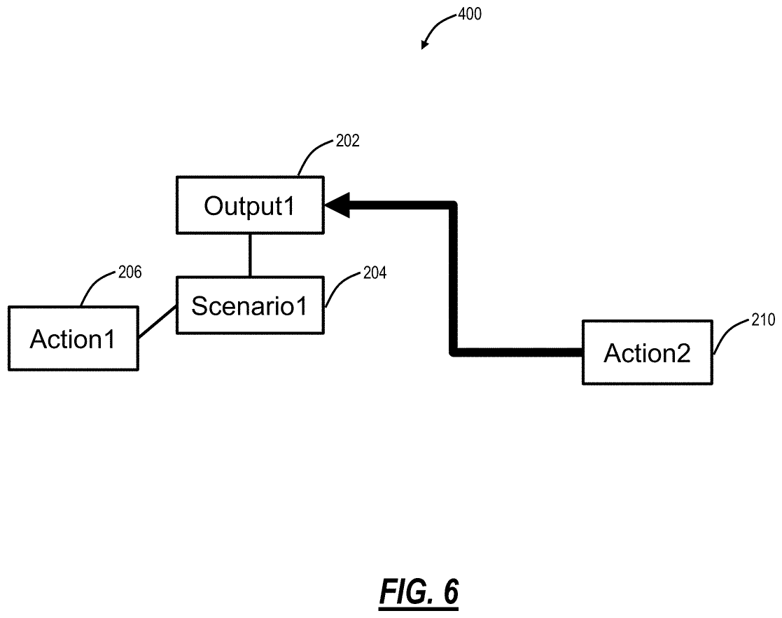

FIG. 6 is a diagram of an example workflow 400 where a separate execution of an action is performed for each element in a list. Here, there is a relationship between the action 210 and the output 202, so the action 210 will be invoked for each element in a list from the output 202.

It may be desirable to perform a separate execution of an action for each element in the list, based on the element's presence in the list, but without being concerned with the element's data. For example, “For each element present in the list, perform a task unrelated to any data in the list.” In this case, no data in each element in the list is consumed, and there is no relationship to the data element in any of the inputs of the action. The presence of the action in the list causes our next action to be executed. This is equivalent to treating the list as a count and executing an operation n times irrespective of the data in the list. For example, the prior action may have been to enumerate all the servers we have. The second action may have been to request authorization for $100 from our infrastructure cost database for each server seen. Note we did not use data such as the names of the server. We simply used the count to make the request iterate on the list.

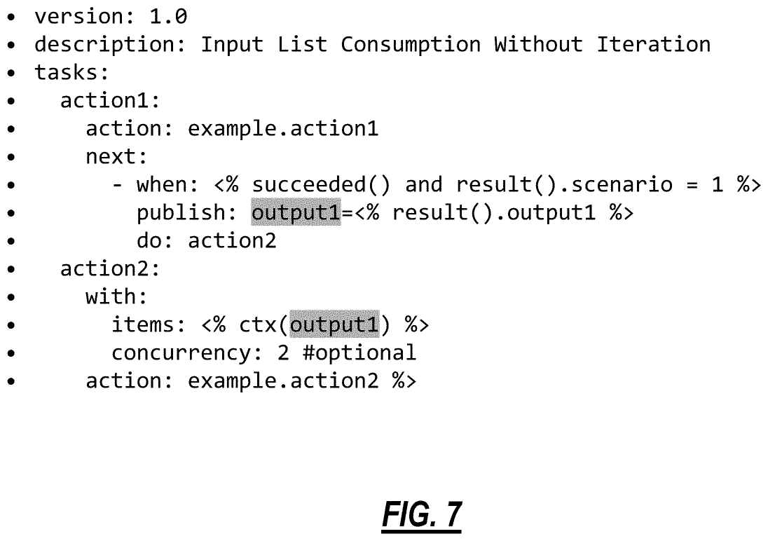

FIG. 7 is an example of code automatically generated based on the workflow 400.

### Combinations

The diagrammatic approach described herein is flexible enough to permit combinations of these two functionalities. The following shows how to simultaneously consume the input list whilst also iterating over the list. This allows the design tool to pass the original list on each iteration for reference while operating on the current item from the same list. It can be useful to know the full context in which data is being operated on.

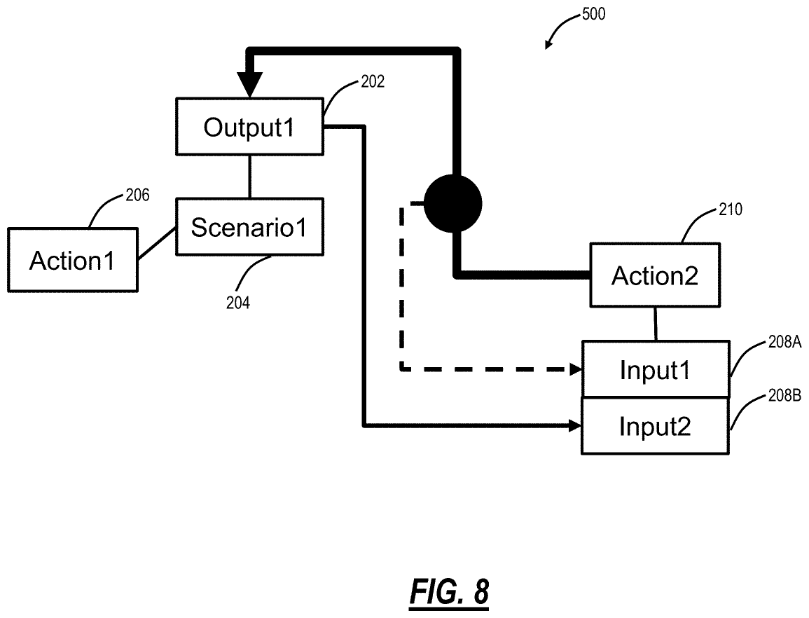

FIG. 8 is a diagram of an example workflow 500, which is a combination of the workflows 200, 300. Here, the action 210 is invoked for each element in the output 202. On this iteration, each element from this iteration is being passed to an input 208A. And the list is being passed in its entirety for each iteration to an input 208B. This is because the output 202 is bound to the input 208B, and there is no relationship link to the black iteration line. This is in contrast with the input 208A, which does have a relationship with that black iteration line, and so for the input 208A, the action 210 receives each item in the list.

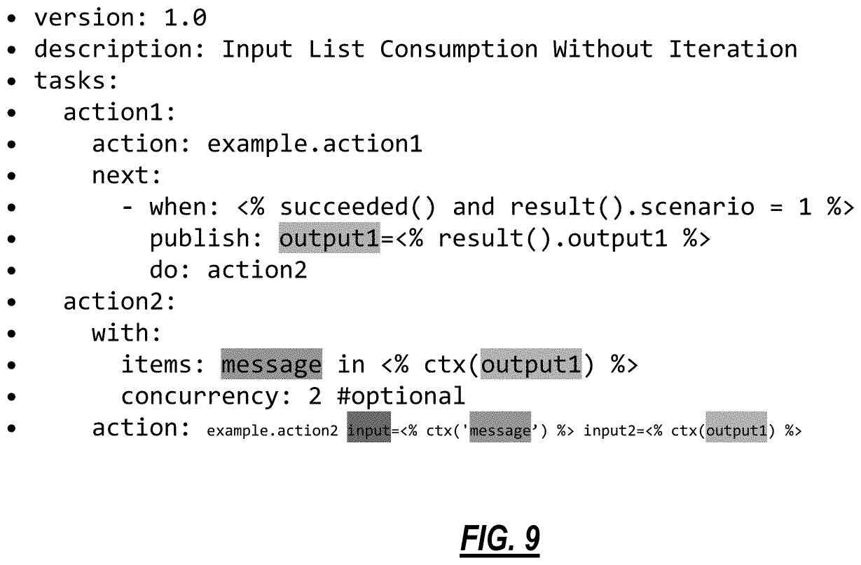

FIG. 9 is an example of code automatically generated based on the workflow 500.

### Zipped Lists

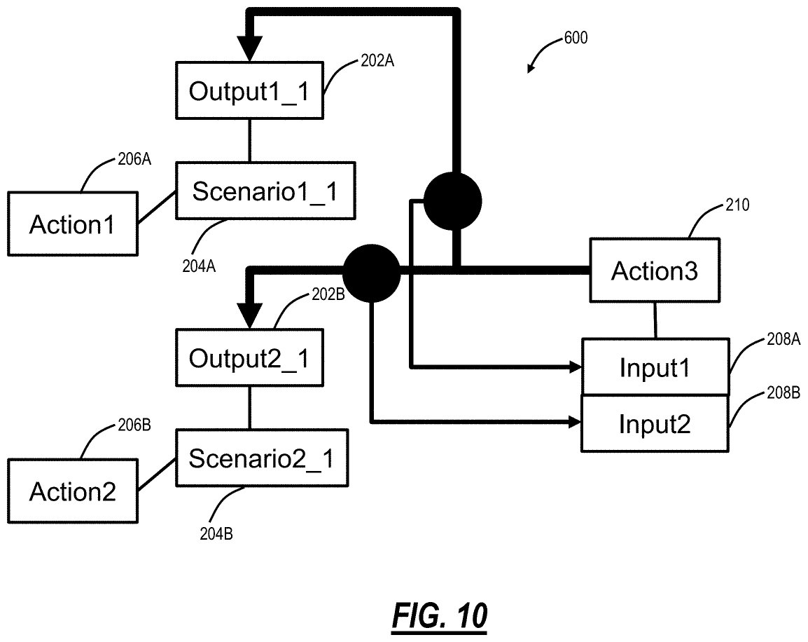

FIG. 10 is a diagram of an example workflow 600 to express zipped lists diagrammatically where given lists of equal size are iterated over the elements as named pairs. The workflow 600 includes three actions 206A, 206B, 210 with the actions 206A, 206B preceding the action 210. Outputs 202A, 202B from scenarios 204A, 204B associated with the actions 206A, 206B. Since the action 210 references both the outputs 202A, 202B, it is possible to derive that these lists are to be zipped. Zipping is where each element of the list with a matching position is paired. Item 1 of list A is paired with item 2 of list B. This allows us to iterate pairwise over both lists. We are then able to bind the inputs 208A, 208B to each respective element of the loop.

The workflow 600 shows how to express zipped lists diagrammatically where given lists of equal size, iterate over the elements as named pairs. This can allow functionality such as “for each server, perform action x.” To do this, a workflow is defined as a workflow with two actions. One action is to enumerate a list of servers. A second action is to enumerate a list of actions. We then provide the ability to zip these two lists together, such that the ‘Action’ is performed on the ‘Server.’ Again, this does not preclude both original lists from being passed in as context. Nor does this require a limit of two lists, this diagrammatic approach can span ‘n’ lists.

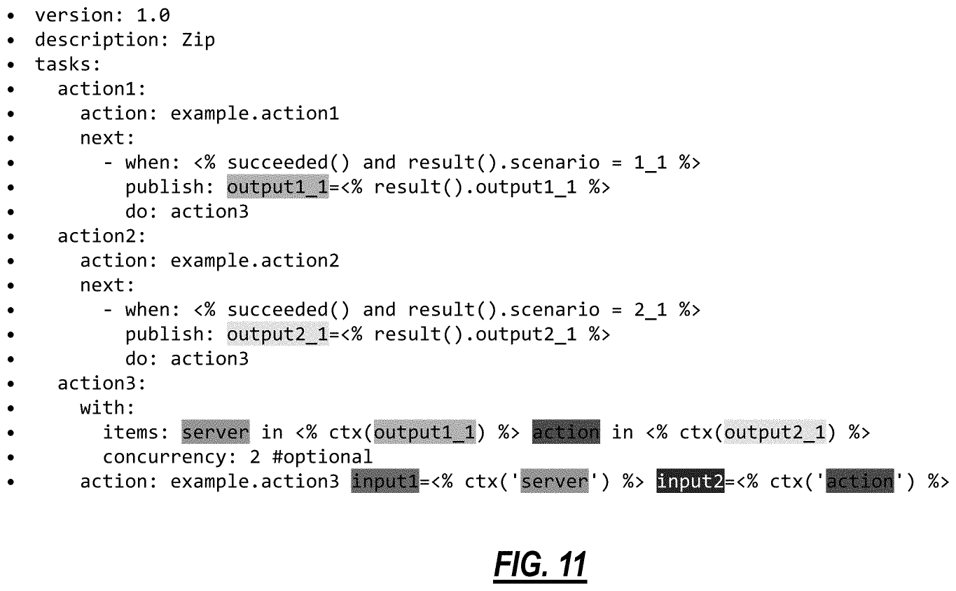

FIG. 11 is an example of code automatically generated based on the workflow 600.

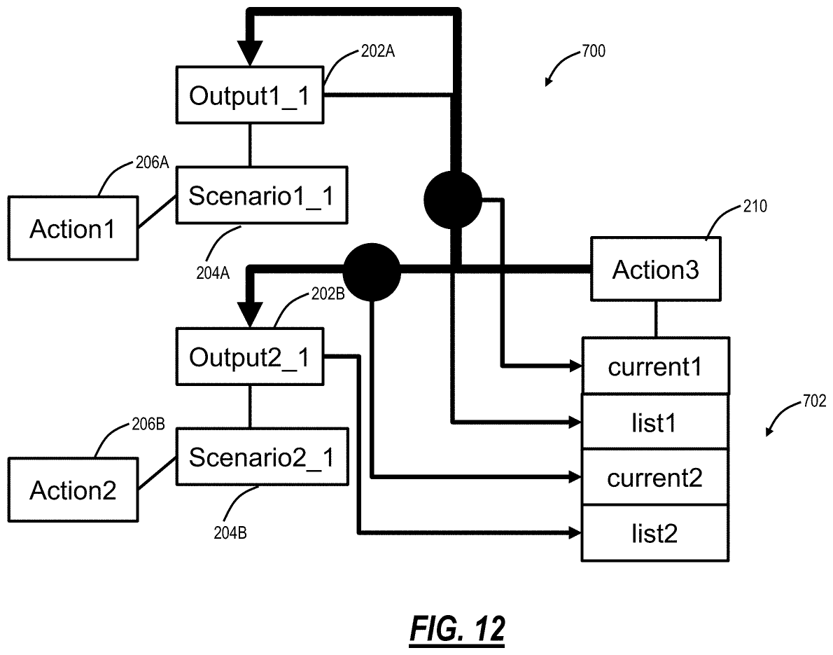

FIG. 12 is a diagram of an example workflow 700 to expand the workflow 600 to provide context. This expands on the workflow 700 to add additional relationships that are not bound to the black iteration lines but are bound to the outputs themselves.

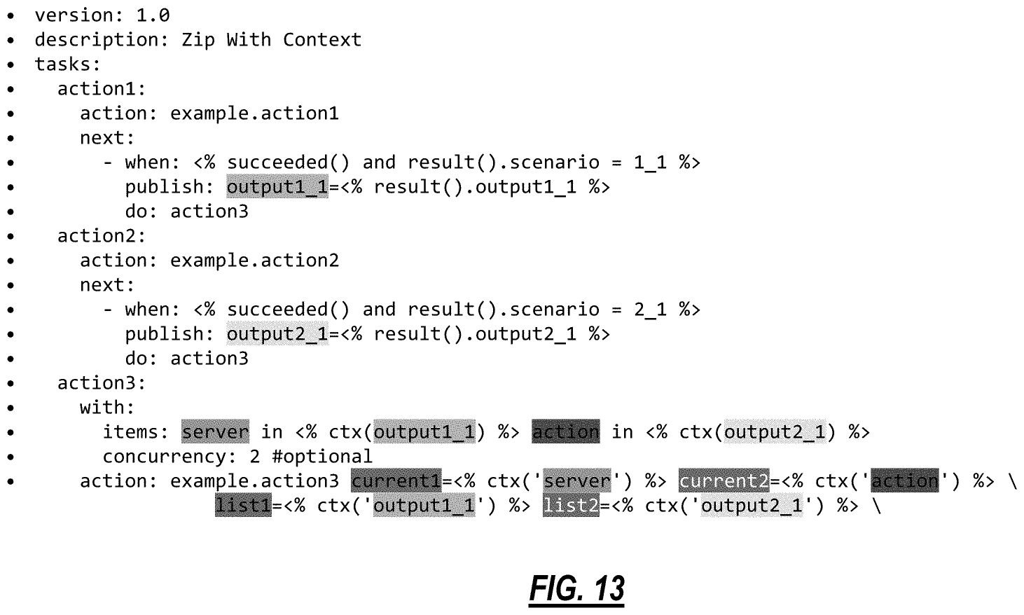

FIG. 13 is an example of code automatically generated based on the workflow 700.

In this code snippet, it can be seen how the current items from both lists, shown here as current1 and current2, are passed in from the server and action bindings. It can also be seen that we pulled in the list1 and list2 and so the full context will be available in this case. All of this code generation was possible without any understanding from the user. The user simply describes these bindings in the abstract as a series of lines and relationships.

### Example UI Schematics

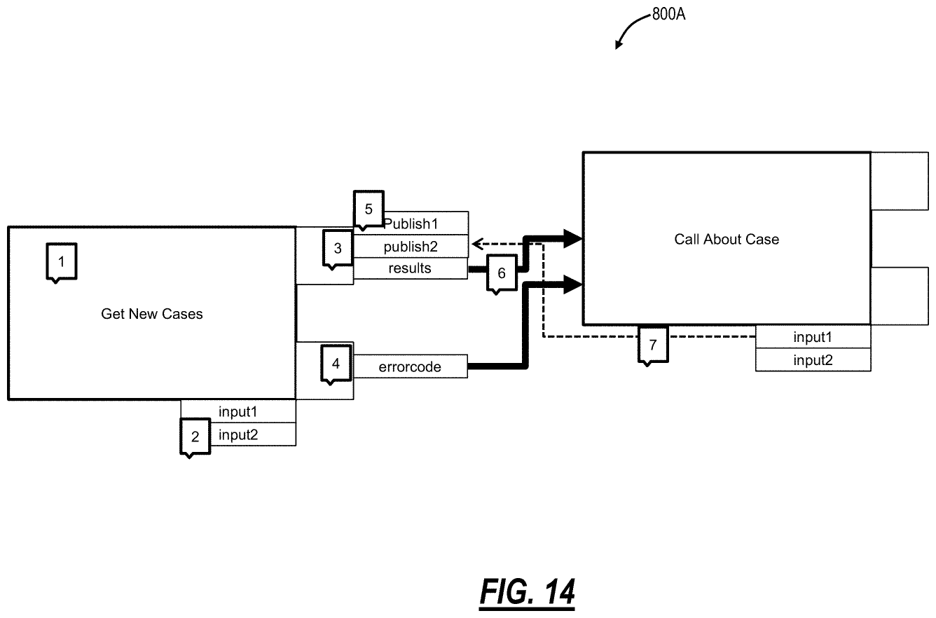

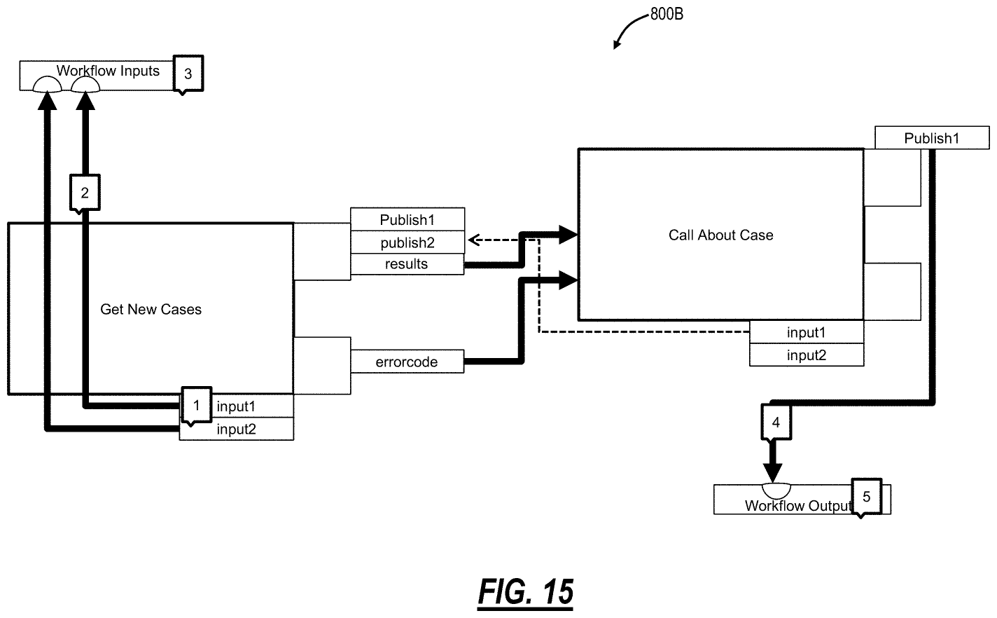

FIGS. 14-22 are diagrams of workflows illustrating a set of concepts and relations that are modeled in the abstract.

FIG. 14 is a diagram of a workflow 800A with actions, inputs, published, do-next, when, and types. Step 1 includes a box representing an ‘Action’ with the friendly name of the action displayed clearly. Double-clicking on this box brings up properties like an area to provide ‘comments’ on what this action is doing and why (the business case). Step 2 includes a list of all the inputs that this action accepts stacked on top of each other. It is possible to draw lines from an Input box to an Output box to describe the relationship here.

Step 3 includes a representation of the ‘when’ construct, each action has a set of predefined “when scenarios,” scenarios could be hidden or visible by default, this depends on user experience and the number of scenarios provided. Step 4 includes an alternative “when scenario” (colored in red to indicate error or danger, or just to be distinct from the other “when scenarios”). Step 5 includes a set of values that are published in this “when scenario.” Note that publication of values depends on the “when scenario.” Step 6 includes a ‘do-next’ scenario, which points to the next action. Multiple arrows can be drawn from the “when scenario” to perform actions in parallel. Step 7 is a data dependency binding. This ensures that that input to the second action is dependent on the published value. This forms input1: “{{ctx( ).publish2}}.”

The code in the workflow 800A can include

```
description: Calculates (a + b) * (c + d)
input:
  - a: 0 # Defaults to value of 0 if input is not provided.
tasks:
  task1:
  action: math.add operand1=<% ctx(a) %> operand2=<% ctx(b) %>
  next:
    - when: <% succeeded( ) %>
```

publish: ab=<% result( ) %>
do: task3 task2:

```
  action: math.add operand1=<% ctx(“c”) %> operand2=<% ctx(“d”) %>
  next.
    - when: <% succeeded( ) %>
```

publish: cd=<% result( ) %>
do:

-task3
-task3-parrallel task3:

```
  join: all
  action: math.multiple operand1=<% ctx(‘ab’) %> operand2=<%
  ctx(‘cd’) %>
  next:
    - when: <% succeeded( ) %>
```

publish: abcd=<% result( ) %>output:

- result: <% ctx( ).abcd %>

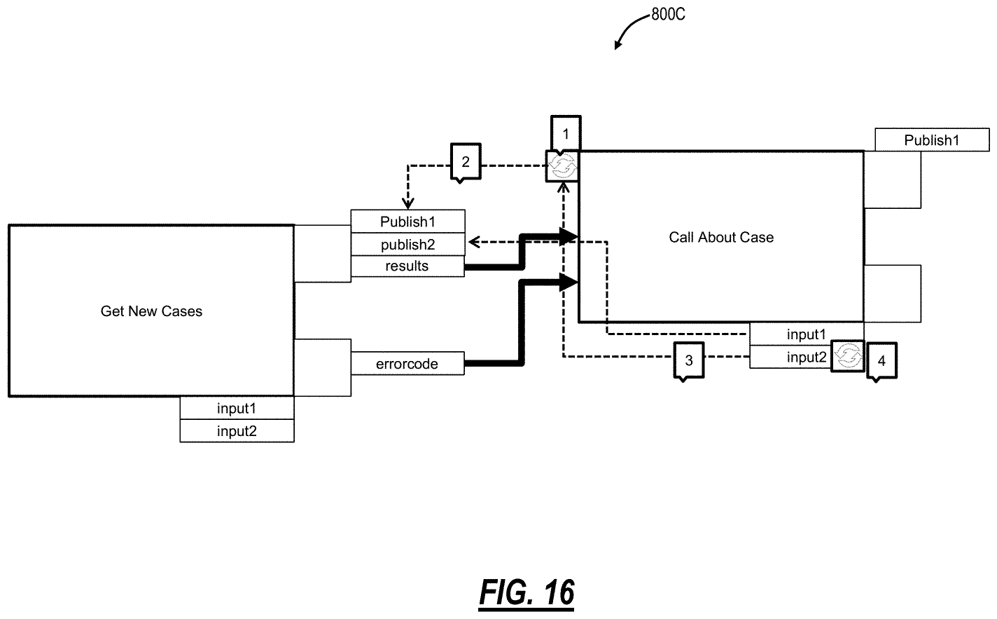

FIG. 16 is a diagram of a workflow 800B with workflow inputs and workflow outputs. At step 1, there is an action input. Step 2 includes a binding from an action input to a workflow input. Step 3 includes a workflow input section. The grey semi-circles are input variable names that are added before drawing a link from the input of an action to the input of a workflow. The name was given to form the public interface for this workflow. This affects the names provided in the autogenerated actions. Step 4 includes a published value that is being pushed into the workflow outputs section. The individual output variables are named. Step 5 is an output box that defines the output parameters (opposite of the input box).

The code in the workflow 800B can include

```
description: Calculates (a + b) * (c + d)
input:
  - a: 0 # Defaults to value of 0 if input is not provided.
  - b: 0
  - c: 0
  - d: 0tasks:
  task1:
  ..
  task2:
  ..
  task3:
  ...
  next:
    - when: <% succeeded( ) %>
```

publish: abcd=<% result( ) %>

output:
- result: <% ctx( ).abcd %>

FIG. 16 is a diagram of a workflow 800C with an ‘items( )’ construct. Step 1 includes a ‘loop’ indicator associated with a particular action that points to a published variable, which is of ‘list’ type. In step 2, the data dependency allows us to point to the published variable. On its own, this allows us to express ‘with: items: {{ctx( ).Publish1}}.’ It invokes the Call Service About Case action a number of times, but the data itself is not being used. On its own, it is just a for(i=i<10; i++) loop that does not read the individual items. Step 3 includes the data dependency indicating that input 2 comes from Publish1. In step 4, the data dependency in step 3 is no ordinary dependency, but expresses itself as input2: ‘<ctx {{item( )}}.’

The code in the workflow 800C can include

```
input:
  - messages
tasks:
  task1:
    with:
```

items: message in <% ctx(messages) %>
concurrency: 2 #optional

action: core.echo message=<% item(message) %>

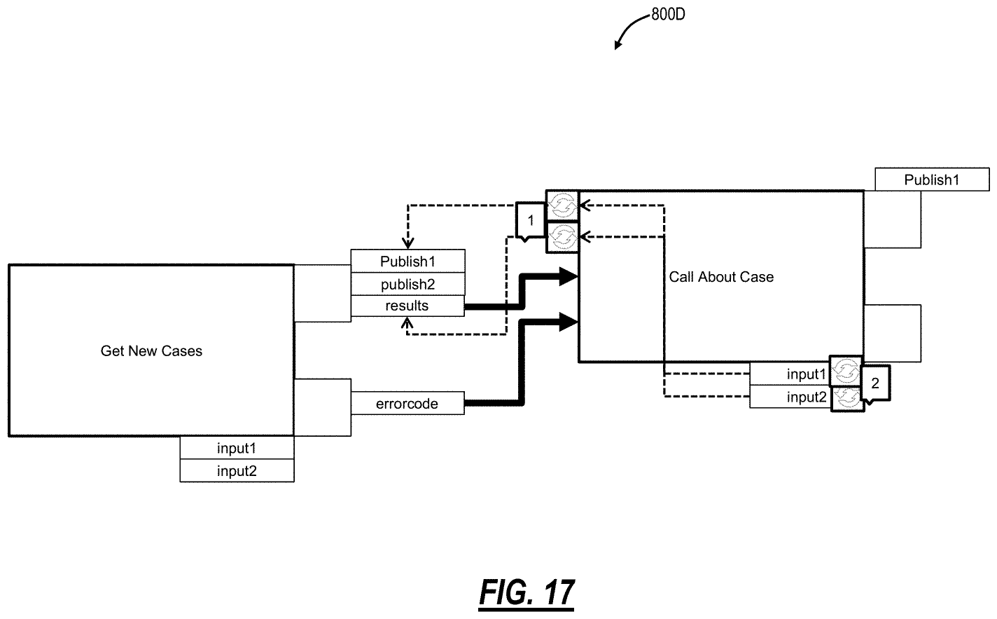

FIG. 17 is a diagram of a workflow 800D with ‘With,’ ‘Zip,’ and named elements. Step 1 includes a pair of loop indicators. This results in an expression that zips the lists together and names each element so it can be referenced later. Step 2 includes a pair of consuming input elements, each element points to the list and results in an expression that uses the named context item.

The code in the workflow 800D can include

```
for each (host, command) {
    //run this command, on this host
}
To do this action 10 times, passing each different value.
input:
  - hosts
  - commands
tasks:
  task1:
```

with: host, command in <% zip(ctx(hosts), ctx(commands)) %>
action: core.remote hosts=<% item(host) %> cmd=<%
item(command) %>

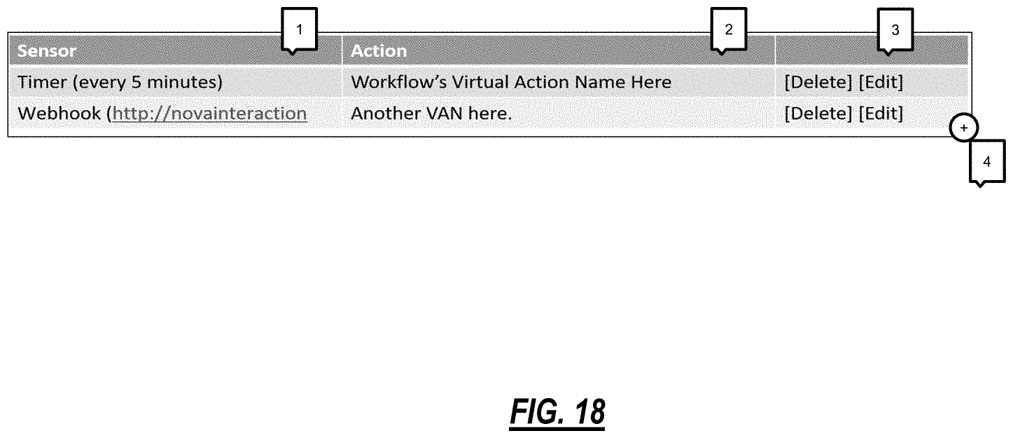

FIG. 18 is a diagram of a rule editor. The rule editor lists a set of related rules that are present in the design tool, it allows multiple rules to be seen in one place, and grouped together. This table exists because showing rules as a gigantic collection of micro flow charts is cumbersome. The rule editor includes a sensor column (1) displaying the sensor and ideally any useful to know configuration. A virtual action (2) is listed to be a trigger. A control panel (3) allows the deleting/editing of the row. Finally, an add button (4) can be used to add more entries to the table.

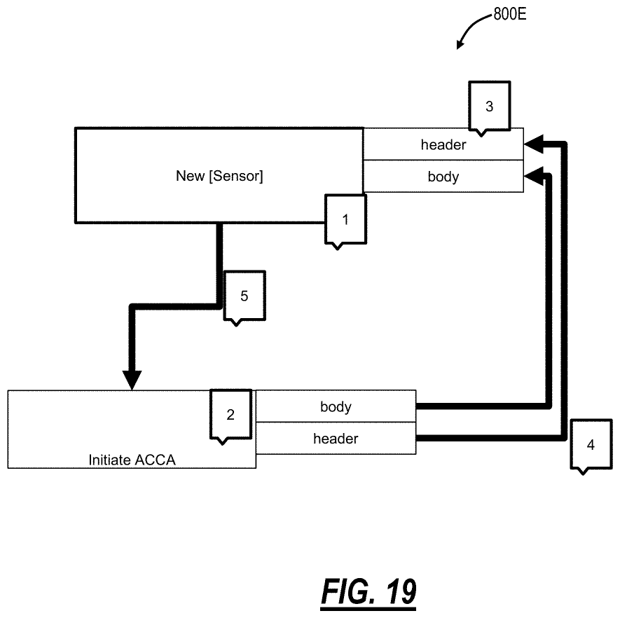

FIG. 19 is a diagram of a workflow 800E for a rule wiring editor. The rule editor allows the user to define how a sensor interacts. For example, a sensor, e.g., a timer sensor, is illustrated (1), and double-clicking allows us to add criteria. A virtual action (2) is autogenerated and placed in the pallet as a result of a workflow having been created and named). This kicks off the workflow 800E. Values like trigger.header can be referenced at step (3). A reference (4) binds the input of the action to the output of the sensor. An arrow (4) is auto-generated but exists for clarity. This arrow is preferable non-editable.

A rule (references trigger/sensor and references Virtual Action, no criteria) can include

```
name: trigger_every_5_mins
pack: exfo_xauto
description: Periodically trigger the polling for new service alerts
enabled: true
trigger:
  parameters:
  delta: 5
  unit: minutes
  type: core.st2.IntervalTimer
criteria: { }
action:
  ref: exfo_xauto.run-service-cca-addition
```

A Virtual Action (implicit from workflow) can include

```
name: add-single-cca-causes
pack: exfo_xauto
description: Annotate a single service anomaly with CCA data from
Another service
runner_type: orquesta
entry_point: workflows/add_single_cca_causes.yaml
enabled: True
parameters:
  anomaly_id:
  type: integer
  service_base_url:
  type: string
  default: http://xauto-poc-service.os.exfo.com:8080
```

An inquiries model can just be a simple yes or no with a customized question and ability to manually enter a jinja template in case one wants to reference variables. A more advanced UI allows interpolation of a selection of variables from a pallet. To migrate over time, the metadata file is versioned, and a specific version of the library is used to model data. The metadata looks very similar to an action, in that it is opinionated when there are choices, initially. The engine can construct advanced inquiries, support custom “when scenarios” for the choices presented to the user. Multiple choice, tick box selections.

description: A basic workflow that demonstrates inquiry.

```
tasks:
  get_approval:
  action: core.ask
  input:
    schema:
```

```
type: object
properties:
  approved:
  type: string
  description: “Continue?”
  required: True
```

```
  next:
    - when: <% succeeded( ) && ctx( ).get_approval.approved = “” %>
```

do: empty

- when: <% failed( ) %>

do: somethingelse

```
  empty:
  action: core.echo message=“Automation completed.”
  somethingelse:
  action: core.echo message=“Automation stopped.”
  next:
    - do: fail
```

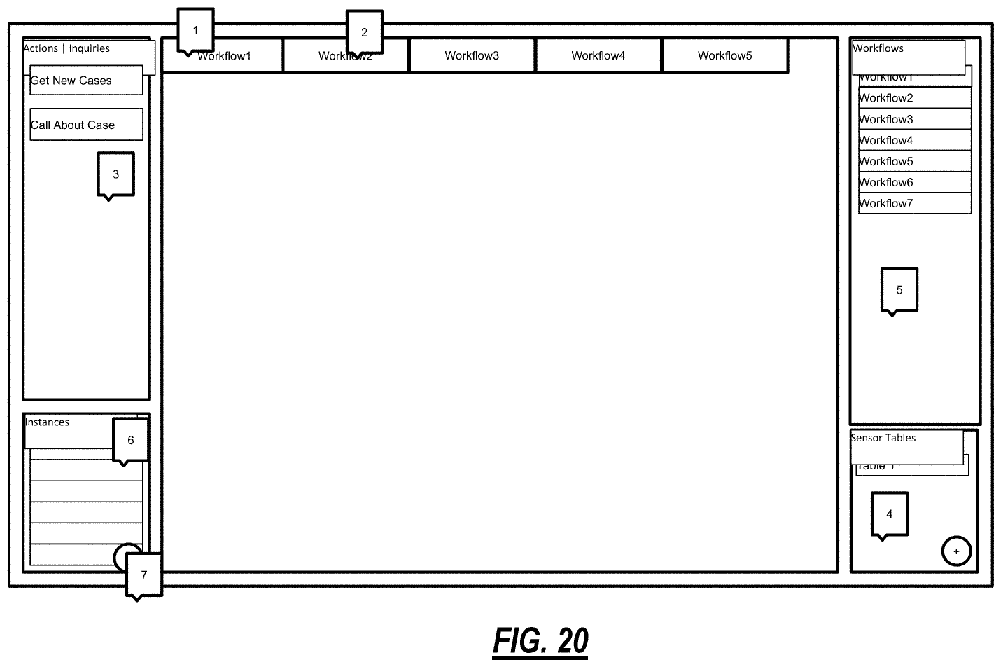

FIG. 20 is a diagram of a GUI for the design tool. The GUI includes (1) an active workflow editor tab, (2) other open workflow editor tabs, (3) a pallet that lists actions. The pallet may also list inquiries, or this could be placed on a separate tab, (4) a list of sensor tables. (Each item in this list is a table, this allows organization and grouping), (5) a list of all the available workflows that have been designed, (6) instances of services (Required to bind to certain actions), and (7) add button to add another instance of a service.

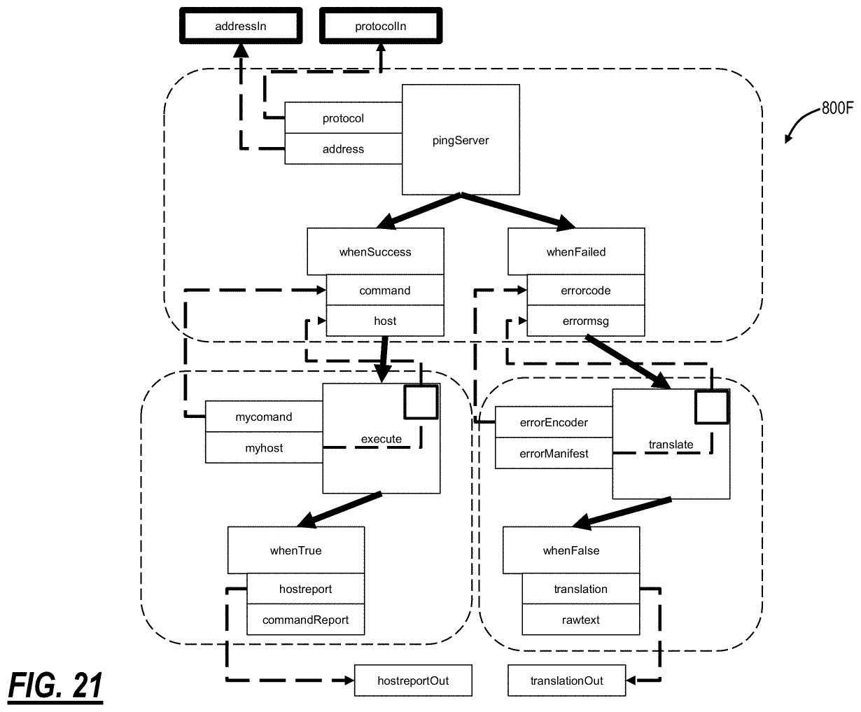

FIG. 21 is a diagram of an example workflow 800F. To manage different parts of the wiring diagram effectively, actions are grouped and their when conditions in a dotted box which can be dragged around.

When the user draws the graph, they are doing so by passing a set of add or remove commands to the backend. For example, when a user adds an Action, an ‘addAction’ is sent to the backend, which stores an instance of the action and some unique ID information in a repository. At some point, the internal graph model produces useful YAML. This is done by wiring together a set of objects that represent the YAML as a POJO structure and filling in the various fields.

Variable generation can include

```
  with:
  items: “message in <% ctx(messages) %>”
action: “exfo_xauto.nodes-from-passive-data”
input:
  case_id: “{{ctx( ).anomaly_id }}”
  url: “http://www.google.com”
next:
- when: “{{ succeeded( ) }}”
  publish:
  - cca_results: “{{ result( ).body }}”
  do:
  - “run_cca”
```

Highlighted Elements in above are fixed (case_id, url, and {{result( ).body}}) and can be pulled from the metadata directly without further modification. Highlighted Elements in above (anomaly_id, cca_results) need to be generated. Ideally, by taking a friendly name, and then appending the uniqueID of the element in question. They are almost always published output names, which suggests that output names need to be generated by taking the metadata name and appending the instance of the output name. This implies that outputs have instance ids. These outputs can be owned by the ‘when’ scenario. The generation approach is encapsulated by the output element.

Of note, in the various graphs described herein, the boxes are vertices for actions, scenarios for the actions, outputs, and inputs. The edges are directed edges, namely they include a flow. The directed edges are between the vertices.

### Integration Use

The various workflows described herein and the design tool can be used by professional services personnel to design and generate code for different applications. This is a common task for integration of different products (hardware and software) such as in networking or other technology fields. For example, different products, from different vendors or even from the same vendor but different product lines, may be integrated with one another, such as where outputs from one product are used as inputs to another, and the like. Again, there can be various implementations as shown in the workflows herein. The conventional approach includes application integration where a professional services team writes software code for each integration. Again, the disadvantage here is the need for code generating expertise and the speed, i.e., it takes significant time to generate code. Further, as expected, there can be a lot of required integration of various applications, and speed and efficiency are critical. In a networking scenario, the different applications (products) can include an alarm application, a Key Performance Indicator (KPI) application, a trouble ticket application, a network topology application, a testing application, a network management application, etc. A simple integration example may include having outputs of the alarm application connect as inputs to the trouble ticket application, i.e., have certain outputs of the alarm application be inputs to the trouble ticket application for creating open tickets based on alarms. Of course, those skilled in the art will recognize various other examples are possible, including ones outside of networking.

The present disclosure allows a professional services team to implement the integration visually and have the code automatically generated. The advantages of this approach include speed, efficiency, accuracy, and cost savings. Specifically, the visualized workflow to code generation ensures accurate code generation, interoperability, and the like. For accuracy, the automated code generation assures the correct code is generated. For interoperability, the automated code generation ensures the proper inputs from one application work with the outputs from another. That is, the design tool can enforce proper interoperability.

### Example Processing Device Architecture

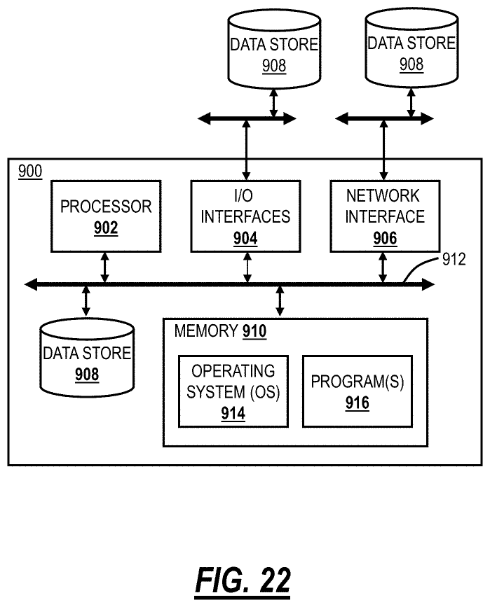

FIG. 22 is a block diagram of a processing device 900 for implementing the design tool. The server 900 may be a digital computer that, in terms of hardware architecture, generally includes a processor 902, input/output (I/O) interfaces 904, a network interface 906, a data store 908, and memory 910. It should be appreciated by those of ordinary skill in the art that FIG. 22 depicts the processing device 900 in an oversimplified manner, and a practical embodiment may include additional components and suitably configured processing logic to support known or conventional operating features that are not described in detail herein. The components (902, 904, 906, 908, and 910) are communicatively coupled via a local interface 912. The local interface 912 may be, for example, but not limited to, one or more buses or other wired or wireless connections, as is known in the art. The local interface 912 may have additional elements, which are omitted for simplicity, such as controllers, buffers (caches), drivers, repeaters, and receivers, among many others, to enable communications. Further, the local interface 912 may include address, control, and/or data connections to enable appropriate communications among the aforementioned components.

The processor 902 is a hardware device for executing software instructions. The processor 902 may be any custom made or commercially available processor, a Central Processing Unit (CPU), an auxiliary processor among several processors associated with the processing device 900, a semiconductor-based microprocessor (in the form of a microchip or chipset), or generally any device for executing software instructions. When the processing device 900 is in operation, the processor 902 is configured to execute software stored within the memory 910, to communicate data to and from the memory 910, and to generally control operations of the processing device 900 pursuant to the software instructions. The I/O interfaces 904 may be used to receive user input from and/or for providing system output to one or more devices or components.

The network interface 906 may be used to enable the processing device 900 to communicate on a network. The network interface 906 may include, for example, an Ethernet card or adapter or a Wireless Local Area Network (WLAN) card or adapter. The network interface 906 may include address, control, and/or data connections to enable appropriate communications on the network. A data store 908 may be used to store data. The data store 908 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 908 may incorporate electronic, magnetic, optical, and/or other types of storage media. In one example, the data store 908 may be located internal to the processing device 900, such as, for example, an internal hard drive connected to the local interface 912 in the processing device 900. Additionally, in another embodiment, the data store 908 may be located external to the processing device 900, such as, for example, an external hard drive connected to the I/O interfaces 904 (e.g., SCSI or USB connection). In a further embodiment, the data store 908 may be connected to the processing device 900 through a network, such as, for example, a network-attached file server.

The memory 910 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 910 may incorporate electronic, magnetic, optical, and/or other types of storage media. Note that the memory 910 may have a distributed architecture, where various components are situated remotely from one another but can be accessed by the processor 902. The software in memory 910 may include one or more software programs, each of which includes an ordered listing of executable instructions for implementing logical functions. The software in the memory 910 includes a suitable Operating System (O/S) 914 and one or more programs 916. The operating system 914 essentially controls the execution of other computer programs, such as the one or more programs 916, and provides scheduling, input-output control, file and data management, memory management, and communication control and related services. The one or more programs 916 may be configured to implement the various processes, algorithms, methods, techniques, etc. described herein.

It will be appreciated that some embodiments described herein may include or utilize one or more generic or specialized processors (“one or more processors”) such as microprocessors; Central Processing Units (CPUs); Digital Signal Processors (DSPs): customized processors such as Network Processors (NPs) or Network Processing Units (NPUs), Graphics Processing Units (GPUs), or the like; Field-Programmable Gate Arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more Application-Specific Integrated Circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured to,” “logic configured to,” etc. perform a set of operations, steps, methods, processes, algorithms, functions, techniques, etc. on digital and/or analog signals as described herein for the various embodiments.

Moreover, some embodiments may include a non-transitory computer-readable medium having instructions stored thereon for programming a computer, server, appliance, device, processor, circuit, etc. to perform functions as described and claimed herein. Examples of such non-transitory computer-readable medium include, but are not limited to, a hard disk, an optical storage device, a magnetic storage device, a Read-Only Memory (ROM), a Programmable ROM (PROM), an Erasable PROM (EPROM), an Electrically EPROM (EEPROM), Flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims.

What is claimed is:

1. A non-transitory computer-readable medium having instructions stored thereon for programming a processing device to perform steps of:
presenting a user interface to a user for generating a workflow;
obtaining a visualization of the workflow via the user interface, wherein the visualization is a directed graph with vertices including actions, scenarios for the actions, outputs, and inputs, and with directed edges between the vertices; and
processing the visualization graph to generate code based thereon.

2. The non-transitory computer-readable medium of claim 1, wherein a directed edge between a prior output to a subsequent input causes consumption of a list, whole and without iteration, associated with the output as the input to an action.

3. The non-transitory computer-readable medium of claim 1, wherein a directed edge between a subsequent action to a prior output binds the output to the action, and an iterative loop on the directed edge causes an input to the action to iterate over a list of the output one at a time.

4. The non-transitory computer-readable medium of claim 1, wherein a directed edge between a subsequent action to a prior output binds the output to the action causing the action to be executed once for each element in the output but without any interest in the data content of the list.

5. The non-transitory computer-readable medium of claim 1, wherein a first directed edge between a prior output to a first input causes consumption of a list associated with the output as the first input to an action, and
wherein a second directed edge between the action to the output binds the output to the action, and an iterative loop on the second directed edge causes a second input to the action to iterate over the list of the output one at a time.

6. The non-transitory computer-readable medium of claim 1, wherein a first directed edge between an action to a first output binds the first output to the action, and a first iterative loop on the first directed edge causes a first input to the action to iterate over a first list of the first output one at a time, and
wherein a second directed edge between the action to a second output binds the second output to the action, and a second iterative loop on the second directed edge causes a second input to the action to iterate over a second list of the second output one at a time.

7. The non-transitory computer-readable medium of claim 1, wherein the code is YAML Ain't Markup Language (YAML).

8. The non-transitory computer-readable medium of claim 1, wherein the code is Extensible Markup Language (XML).

9. The non-transitory computer-readable medium of claim 1, wherein the code is JavaScript Object Notation (JSON).

10. A processing device comprising:
one or more processors and memory storing instructions that, when executed, cause the one or more processors to
present a user interface to a user for generating a workflow,
obtain a visualization of the workflow via the user interface, wherein the visualization is a directed graph with vertices including actions, scenarios for the actions, outputs, and inputs, and with directed edges between the vertices, and
process the visualization graph to generate code based thereon.

11. The processing device of claim 10, wherein a directed edge between a prior output to a subsequent input causes consumption of a list, whole and without iteration, associated with the output as the input to an action.

12. The processing device of claim 10, wherein a directed edge between a subsequent action to a prior output binds the output to the action, and an iterative loop on the directed edge causes an input to the action to iterate over a list of the output one at a time.

13. The processing device of claim 10, wherein a directed edge between an action to an output binds the output to the action.

14. The processing device of claim 10, wherein a first directed edge between an output to a first input causes consumption of a list associated with the output as the first input to an action, and
wherein a second directed edge between the action to the output binds the output to the action, and an iterative loop on the second directed edge causes a second input to the action to iterate over the list of the output one at a time.

15. The processing device of claim 10, wherein a first directed edge between an action to a first output binds the first output to the action, and a first iterative loop on the first directed edge causes a first input to the action to iterate over a first list of the first output one at a time, and
wherein a second directed edge between the action to a second output binds the second output to the action, and a second iterative loop on the second directed edge causes a second input to the action to iterate over a second list of the second output one at a time.

16. A method comprising:
presenting a user interface to a user for generating a workflow;
obtaining a visualization of the workflow via the user interface, wherein the visualization is a directed graph with vertices including actions, scenarios for the actions, outputs, and inputs, and with directed edges between the vertices; and
processing the visualization graph to generate code based thereon.

17. The method of claim 16, wherein a directed edge between a prior output to a subsequent input causes consumption of a list, whole and without iteration, associated with the output as the input to an action.

18. The method of claim 16, wherein a directed edge between an action to an output binds the output to the action, and an iterative loop on the directed edge causes an input to the action to iterate over a list of the output one at a time.

19. The method of claim 16, wherein a directed edge between an action to an output binds the output to the action.

20. The method of claim 16, wherein a first directed edge between an output to a first input causes consumption of a list associated with the output as the first input to an action, and
wherein a second directed edge between the action to the output binds the output to the action, and an iterative loop on the second directed edge causes a second input to the action to iterate over the list of the output one at a time.
